(19) United States
(12) Patent Application Publication
(10) Pub. No.: US 2018/0255264 A1
(43) Pub. Date: Sep. 6, 2018

(54) ELECTRONIC APPARATUS FOR PLAYING SUBSTITUTIONAL ADVERTISEMENT AND CONTROLLING METHOD THEREOF

(71) Applicant: SAMSUNG ELECTRONICS CO., LTD., Suwon-si (KR)

(72) Inventor: Oh In KWON, Seoul (KR)

(73) Assignee: SAMSUNG ELECTRONICS CO., LTD., Suwon-si (KR)

(21) Appl. No.: 15/912,017

(22) Filed: Mar. 5, 2018

(30) Foreign Application Priority Data
Mar. 2, 2017 (KR) 10-2017-0027233

(51) Int. Cl. H04N 5/445; H04N 21/431; H04N 21/81; G06T 5/50

(52) U.S. Cl. CPC H04N 5/44543; H04N 21/4316; G06T 2207/20221; G06T 5/50; H04N 21/8153; H04N 21/812

(57) ABSTRACT

A display apparatus includes a communication interface connected to a broadcasting reception apparatus and a server, a display displaying an image, and a processor electrically connected to the communication interface and the display. The processor is configured to receive a first image from the broadcasting reception apparatus, to receive a second image, and a third image with which the first image is substituted and which is to be displayed in the display, from the server, to determine whether a user interface (UI) image generated by the broadcasting reception apparatus is blended into the first image, in response to determining that the UI image is blended into the first image, to remove the second image from the first image to generate the UI image, and to blend the UI image into the third image in order to display the blended image in the display.

### CROSS-REFERENCE TO RELATED APPLICATION(S)

This application is based on and claims priority under 35 U.S.C. § 119 from Korean Patent Application No. 10-2017-0027233, filed on Mar. 2, 2017, in the Korean Intellectual Property Office, the disclosure of which is incorporated herein by reference in its entirety.

### BACKGROUND

### 1. Field

The present disclosure relates to a display apparatus that plays a substitutional advertisement, and a controlling method of the display apparatus.

### 2. Description of Related Art

With the development of various types of electronic devices as well as the development of a broadcasting technology and an Internet communication technology, a variety of content may be provided to a user. In particular, thanks to the development of mobile devices such as a notebook personal computer (PC), a smartphone, a tablet PC, or the like, the mobile device may provide a user with the variety of content.

In addition to providing the same content to a plurality of users unilaterally by using the mobile device, it may be possible to provide the plurality of users with different content by using user information that corresponds to each individual mobile device.

The above information is presented as background information only to assist with an understanding of the present disclosure. No determination has been made, and no assertion is made, as to whether any of the above might be applicable as prior art with regard to the present disclosure.

### SUMMARY

A broadcasting reception apparatus providing a broadcasting image to a display apparatus may blend a user interface (UI) image into the broadcasting image to be transmitted to the display apparatus. In the case where the display apparatus substitutes for an advertisement image, which is included in the broadcasting image received from the broadcasting reception apparatus, with a substitutional advertisement image received from a server in order to display the substitutional advertisement image in a display, a UI image blended into the advertisement image may not be displayed in the display apparatus. As such, the display apparatus may not provide a user with a user experience (UX) through a UI.

In the case where the substitutional advertisement image is displayed, a display apparatus according to various embodiments of the present disclosure may provide a user with the UX through the UI, by extracting a UI image, which is blended into a broadcasting image and received from a broadcasting reception apparatus, in order to display the blended UI image in a display.

In accordance with an aspect of the present disclosure, a display apparatus includes a communication interface connected to each of a broadcasting reception apparatus and a server, a display configured to display an image, and a processor electrically connected to each of the communication interface and the display. The processor is configured to receive a first image from the broadcasting reception apparatus, to receive a second image from the server, and receive, from the server, a third image with which the first image are substituted and which is to be displayed in the display. The processor is further configured to determine whether a user interface (UI) image generated by the broadcasting reception apparatus is blended into the first image, and in response to determining that the UI image is blended into the first image, to remove the second image from the first image in order to generate the UI image, and to blend the UI image into the third image in order to generate a blended image, and then to display the blended image in the display.

In accordance with another aspect of the present disclosure, a controlling method of a display apparatus includes receiving a first image from a broadcasting reception apparatus, receiving a second image from a server, and receiving, from the server, a third image with which the first image is substituted and which is to be displayed. The method further includes determining whether a UI image generated by the broadcasting reception apparatus is blended into the first image, in response to determining that the UI image is blended into the first image, removing the second image from the first image in order to generate the UI image, blending the UI image into the third image in order to generate a blended image, and displaying the blended image in a display.

In accordance with another aspect of the present disclosure, a non-transitory computer-readable recording medium having recorded thereon a program for performing a method is provided. The method includes: receiving a first image from a broadcasting reception apparatus; receiving a second image from a server; and receiving, from the server a third image, with which a second image and the first image is substituted and which is to be displayed in the display. The method further includes determining whether a UI image generated by the broadcasting reception apparatus is blended into the first image; in response to determining that the UI image is blended into the first image, removing the second image from the first image in order to generate the UI image; blending the UI image into the third image in order to generate a blended image; and displaying the blended image in a display.

According to an embodiment of the present disclosure, when receiving an image into which a UI image is blended from a broadcasting reception apparatus, a display apparatus and a controlling method of the display apparatus may remove a broadcasting image received from an advertisement server from an image received from a broadcasting reception apparatus, to extract the UI image and may blend the UI image into a substitutional advertisement image to display the blended image, and thus may provide a user with a UX through the UI.

In addition, the display apparatus may blend the UI image with the substitutional advertisement so as to be the same as the UI image in the broadcasting image and may display the blended image, by extracting the blended UI image from the image, which is received from the broadcasting reception apparatus, based on the value of the blended alpha value α of the UI image, in the case where the UI image is semi-transparently blended into a broadcasting image.

In addition, a variety of effects which may be directly or indirectly understood through this disclosure may be provided.

Other aspects, advantages, and salient features of the disclosure will become apparent to persons having ordinary in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a substitutional advertisement providing system, according to various embodiments;

FIG. 2 is a block diagram illustrating a configuration of a display apparatus, according to an embodiment;

FIG. 3 is a view illustrating a program module included in a display apparatus, according to an embodiment;

FIGS. 4AA, 4AB, 4B, 4CA, and 4CB are views of a method in which a display apparatus blends a UI image of a broadcasting reception apparatus in a substitutional advertisement;

FIGS. 5AA, 5AB, 5BA, 5BB, and 5C are views of a method in which a display apparatus blends a UI image of a broadcasting reception apparatus in a substitutional advertisement; and

FIG. 6 is a flowchart illustrating a control method of a display apparatus, according to an embodiment.

### DETAILED DESCRIPTION

Hereinafter, various embodiments will be described with reference to accompanying drawings. However, persons having ordinary skill in the art will recognize that modifications, equivalents, and/or alternatives on the various embodiments described herein can be variously made without departing from the scope and spirit of the present disclosure. With regard to description of drawings, similar elements may be marked by similar reference numerals.

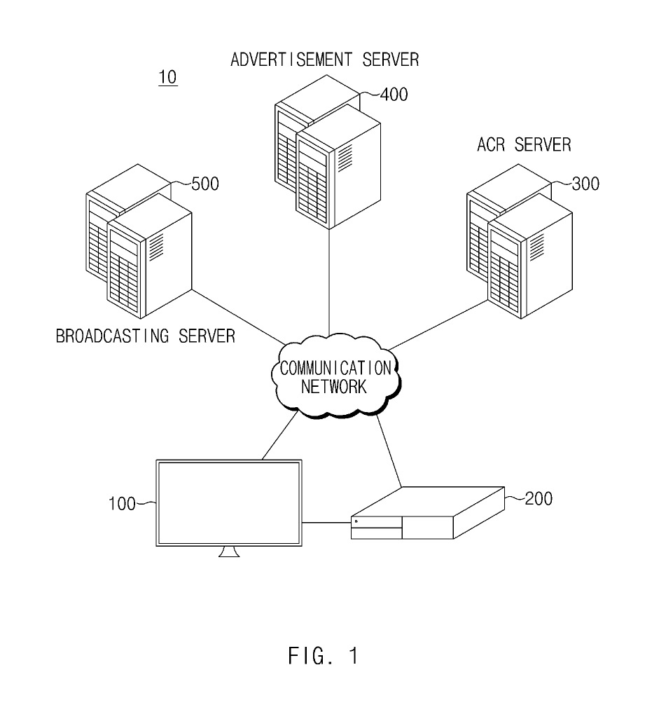

FIG. 1 is a view illustrating a substitutional advertisement providing system, according to various embodiments.

Referring to FIG. 1, a substitutional advertisement system 10 may include a display apparatus 100, a broadcasting reception apparatus 200, an automatic content recognition (ACR) server 300, an advertisement server 400, and a broadcasting server 500. The display apparatus 100 may play the content and the advertisement, which are received from the broadcasting server 500. The content and advertisement may include at least one image (e.g., a video image) and audio signals.

The display apparatus 100 may receive a broadcasting image from the broadcasting reception apparatus 200. For example, the display apparatus 100 may be connected to the broadcasting reception apparatus 200 by wire (e.g., a high definition multimedia interface (HDMI) or a digital video/visual interactive (DVI), a display port (DP), a video graphics array (VGA), or the like) or wirelessly (e.g., wireless-fidelity (Wi-Fi), wireless high definition (HD) (WiHD), wireless gigabit (WiGig), or the like) so as to receive the broadcasting image. For example, the broadcasting image may include a content image (e.g., a broadcasting program) or an advertisement image. According to an embodiment, the display apparatus 100 may display the broadcasting image in a display.

According to an embodiment, the display apparatus 100 may receive information of a channel that corresponds to an image to be displayed in a display from the ACR server 300. For example, the display apparatus 100 may be connected to the ACR server 300 via a communication network (e.g., an IP communication network) to receive the channel information. The display apparatus 100 may transmit image identification information that is generated based on the image to be displayed in the display to the ACR server 300 and may receive channel information that corresponds to the image identification information.

According to an embodiment, the display apparatus 100 may receive a substitutional advertisement image from the advertisement server 400. For example, the display apparatus 100 may be connected to the advertisement server 400 via the communication network (e.g., the IP communication network) to receive the substitutional advertisement image. The display apparatus 100 may receive the substitutional advertisement image, which will substitute for an advertisement image of a broadcasting image received from the broadcasting reception apparatus 200, based on the channel information received from the ACR server 300. According to an embodiment, the display apparatus 100 may substitute the broadcasting image, which is received from the broadcasting reception apparatus 200, with the substitutional advertisement image in order to display the substitutional advertisement image in a display. For example, the substitutional advertisement image may be displayed in the display by substituting an advertisement image included in the broadcasting image received from the broadcasting reception apparatus 200.

According to an embodiment, the display apparatus 100 may be implemented with any of various apparatuses, which are able to receive content from an external device and to display the content, such as a television (TV), a desktop, a notebook PC, a smartphone, a tablet PC, a monitor, an electronic frame, and the like.

The broadcasting reception apparatus 200 may receive a broadcasting image from the broadcasting server 500. For example, the broadcasting reception apparatus 200 may be connected to the broadcasting server 500 via a communication network (e.g., a radio frequency (RF) communication network or an Internet Protocol (IP) communication network) to receive the broadcasting image. For example, the broadcasting image may include a content image (e.g., a broadcasting program) and/or an advertisement image.

According to an embodiment, the broadcasting reception apparatus 200 may transmit the broadcasting image to the display apparatus 100. According to an embodiment, the broadcasting reception apparatus 200 may blend the received broadcasting image with a user interface (UI) image in order to transmit the blended image to the display apparatus 100. For example, if a user input is received, the broadcasting reception apparatus 200 may blend the broadcasting image with an UI image that corresponds to the user input in order to transmit the blended image to the display apparatus 100.

According to an embodiment, the broadcasting reception apparatus 200 may be implemented by using any of various apparatuses that are capable of receiving or storing broadcasting content and transmitting the broadcasting content to the display apparatus 100, such as a set-top box.

The ACR server 300 may verify a channel that corresponds to the broadcasting image displayed in the display apparatus 100. For example, the ACR server 300 may verify a channel that corresponds to the image displayed in the display apparatus 100 based on image identification information received from the display apparatus 100. According to an embodiment, the ACR server 300 may transmit information about the verified channel to the display apparatus 100.

The advertisement server 400 may transmit a substitutional advertisement to the display apparatus 100. For example, the advertisement server 400 may receive a request for the substitutional advertisement from the display apparatus 100 and may transmit the substitutional advertisement image to the display apparatus 100 in response to the request.

The broadcasting server 500 may transmit the broadcasting image to the broadcasting reception apparatus 200. For example, the broadcasting server 500 may transmit the broadcasting image that corresponds to the channel selected by the broadcasting reception apparatus 200 to the broadcasting reception apparatus 200. For example, the broadcasting image may include a content image (e.g., a broadcasting program) and an advertisement image.

The UI image generated by the broadcasting reception apparatus 200 in response to a user input may be blended into the broadcasting image that the broadcasting reception apparatus 200 transmits to the display apparatus 100. In the case where the display apparatus 100 substitutes the advertisement image received from the broadcasting reception apparatus 200 with the substitutional advertisement image received from the advertisement server 400 in order to display the substitutional advertisement image in a display, a UI image blended into the advertisement image may not be displayed in the display apparatus 100. As such, the display apparatus 100 may not provide a user with a user experience (UX) through a UI. In the case where the substitutional advertisement image is displayed, the display apparatus 100 according to various embodiments may provide a user with the UX through the UI by extracting a UI image, which is blended into a broadcasting image, received from the broadcasting reception apparatus 200 in order to display the UI image in the display 130.

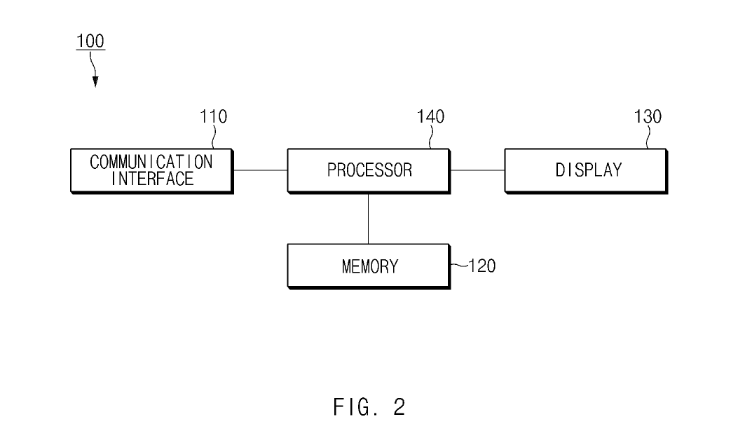

FIG. 2 is a block diagram illustrating a configuration of a display apparatus, according to an embodiment.

Referring to FIG. 2, the display apparatus 100 may include a communication interface 110, a memory 120, a display 130, and a processor 140.

The communication interface 110 may be connected with an external device so as to transmit data to and receive data from the external device. For example, the communication interface 110 may be connected to the broadcasting reception apparatus 200 so as to receive a broadcasting image from the broadcasting reception apparatus 200. The communication interface 110 may be connected to the ACR server 300 so as to transmit image identification information to the ACR server 300 and so as to receive channel information that corresponds to the image identification information from the ACR server 300. The communication interface 110 may be connected to the advertisement server 400 so as to transmit a substitutional advertisement request to the advertisement server 400 and so as to receive a substitutional advertisement that is responsive to the request from the advertisement server 400.

According to an embodiment, the memory 120 may store information about the UI image generated by the broadcasting reception apparatus 200. For example, the memory 120 may store display area information of the UI image that is capable of being blended into the broadcasting image by the broadcasting reception apparatus 200. For example, the display area information may include at least one of the size of the UI image and the location information.

The display 130 may display an image received from an external apparatus. For example, the display 130 may display the broadcasting image (e.g., a content image or an advertisement image) received from the broadcasting reception apparatus 200. The display 130 may substitute the advertisement image received from the broadcasting reception apparatus 200 with the substitutional advertisement image received from the advertisement server 400 in order to display the substitutional advertisement image.

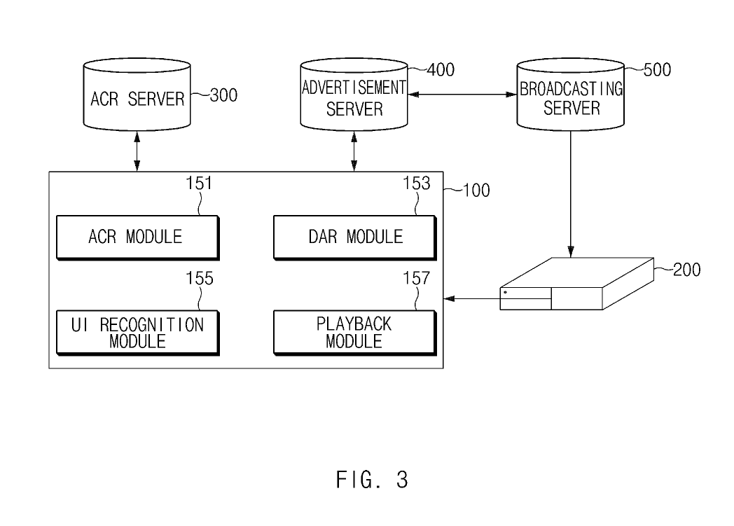

The processor 140 may control overall operations of the display apparatus 100. For example, the processor 140 may control the communication interface 110, the memory 120, and the display 130 to blend the UI image generated by the broadcasting reception apparatus 200 into a substitutional advertisement image for the purpose of displaying the substitutional advertisement image in the display 130. The operation of the processor 140 for blending the UI image into the substitutional advertisement image will be described below with reference to FIGS. 3 to 5C.

FIG. 3 is a view illustrating a program module included in a display apparatus, according to an embodiment.

Referring to FIG. 3, a program module (e.g., application) included in the display apparatus 100 may include an ACR module 151, a digital advertisement replacement (DAR) module 153, a UI recognition module 155, and a playback module 157. The program modules may be stored in the memory 120. After being executed by the processor 140, the program modules may perform their operation.

The ACR module 151 may generate image identification information based on an image displayed in the display 130. For example, the ACR module 151 may capture the image displayed in the display 130 and may generate image identification information (e.g., fingerprint information or watermark information) by using the captured image. For example, the ACR module 151 may reduce the captured image and may extract minutiae representing the captured image in order to generate fingerprint information. As another example, the ACR module 151 may extract a unique watermark inserted into the captured image, in order to generate watermark information. According to an embodiment, the ACR module 151 may transmit the image identification information to the ACR server 300.

According to an embodiment, the ACR server 300 may use the image identification information to verify a channel that corresponds to the image identification information. For example, the ACR server 300 may include a database that stores the image identification information corresponding to each broadcasting channel. The ACR server 300 may compare the image identification information received from the ACR module 151 with image identification information for each broadcasting channel, which is stored in the database, in order to verify a channel (or channel information) that corresponds to the image identification information.

According to an embodiment, the ACR server 300 may verify a broadcasting schedule (e.g., a broadcasting program schedule or an advertisement schedule) of the channel that corresponds to the verified channel information. For example, the ACR server 300 may determine whether a substitutable advertisement is included in the channel that corresponds to the channel information, by using broadcasting schedules of a plurality of channels stored in the database. If the substitutable advertisement is included in the channel that corresponds to the channel information, the ACR server 300 may verify information (e.g., the start time of an advertisement, identification information of an advertisement, or the like) about the substitutable advertisement. The ACR server 300 may transmit, to the display apparatus 100, the channel information and the information about the substitutable advertisement of the channel that corresponds to the channel information. According to an embodiment, at least one of operations performed by the ACR server 300 may be performed by the ACR module 151.

According to an embodiment, if the information about the substitutable advertisement is received from the ACR server 300, the DAR module 153 may transmit, to the advertisement server 400, a request (or a substitutional advertisement request) for receiving a substitutional advertisement. The substitutional advertisement request may include information that is usable and/or necessary for the advertisement server 400 to select the substitutional advertisement. For example, the substitutional advertisement request may include the information about the substitutable advertisement and user profile information (e.g., residence area, gender, age, interest, or the like).

According to an embodiment, the advertisement server 400 may transmit the substitutional advertisement (or a substitutional advertisement image) to the display apparatus 100 in response to the request of the DAR module 153. According to an embodiment, the advertisement server 400 may select the substitutional advertisement based on at least one of the information about the substitutable advertisement included in the substitutional advertisement request and the user profile information and may transmit the selected substitutional advertisement to the display apparatus 100.

According to an embodiment, the DAR module 153 may transmit a request (or a request of a broadcasting image) for receiving the broadcasting image that corresponds to the verified channel via the ACR server 300, to the advertisement server 400. For example, the request of the broadcasting image may include channel information received from the ACR server 300.

According to an embodiment, the advertisement server 400 may transmit the broadcasting image of the channel that corresponds to the channel information to the display apparatus 100 in response to the request of the DAR module 153. According to an embodiment, the advertisement server 400 may receive the broadcasting image from the broadcasting server 500 and may transmit the broadcasting image of the channel that corresponds to channel information to the display apparatus 100. The broadcasting image that the advertisement server 400 transmits to the display apparatus 100 may be an original broadcasting image into which an UI image generated by the broadcasting reception apparatus 200 is not blended.

According to an embodiment, the UI recognition module 155 may determine whether the broadcasting image received from the broadcasting reception apparatus 200 is different from the broadcasting image received from the advertisement server 400. The UI recognition module 155 may compare a respective pixel value of the image received from the broadcasting reception apparatus 200 with a corresponding pixel value of the image received from the advertisement server 400 to determine whether the image received from the broadcasting reception apparatus 200 is different from the image received from the advertisement server 400.

According to an embodiment, the UI recognition module 155 may determine whether the UI image is blended into the image received from the broadcasting reception apparatus 200. If the image received from the broadcasting reception apparatus 200 is different from the image received from the advertisement server 400, the UI recognition module 155 may determine whether the UI image is blended into the image received from the broadcasting reception apparatus 200. For example, the UI recognition module 155 may compare a respective pixel value of the image received from the broadcasting reception apparatus 200 with a corresponding pixel value of the image received from the advertisement server 400; if the number of the same pixels is not less than (or when a number of the same pixels for which a pixel value thereof is equal is greater than and equal to) a predetermined number, the UI recognition module 155 may determine that the UI image is blended into the image received from the broadcasting reception apparatus 200. As another example, the UI recognition module 155 may determine whether the UI image is blended into the image received from the broadcasting reception apparatus 200, based on information about the display area of the UI image stored in the memory 120. For example, the UI recognition module 155 may verify an area within which respective pixel values in the image received from the broadcasting reception apparatus 200 are different from corresponding pixel values in the broadcasting image received from the advertisement server 400. If the verified area is the same as the display area of the UI image by a specified ratio or more, the UI recognition module 155 may determine that the UI image is blended into the image received from the broadcasting reception apparatus 200.

According to an embodiment, if (or in response to determining that) the UI image is blended into the advertisement image received from the broadcasting reception apparatus 200, the UI recognition module 155 may generate an UI image by using the channel image. For example, the UI recognition module 155 may remove the channel image from the image received from the broadcasting reception apparatus 200 in order to generate the UI image.

According to an embodiment, the DAR module 153 may blend the generated UI image into the substitutional advertisement image received from the advertisement server 400. According to an embodiment, the DAR module 153 may display the substitutional advertisement image, into which the UI image is blended, in the display 130 by using the playback module 157. For example, the DAR module 153 may display the substitutional advertisement image in the display 130 based on information (e.g., the start time of an advertisement, identification information of an advertisement, or the like) about the substitutable advertisement verified through the ACR server 300.

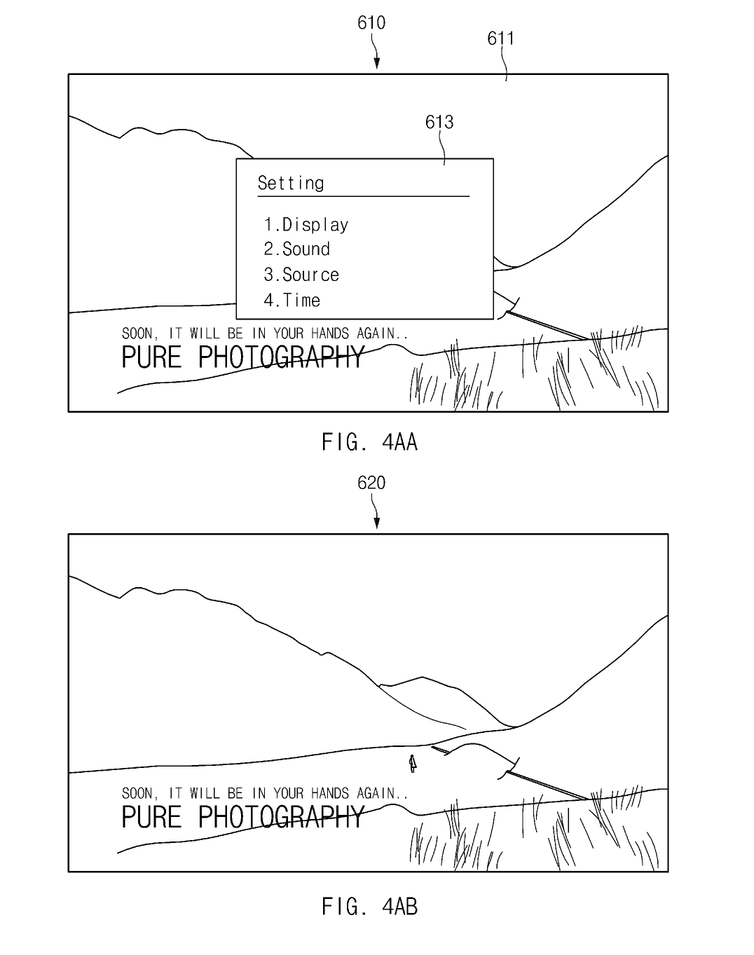

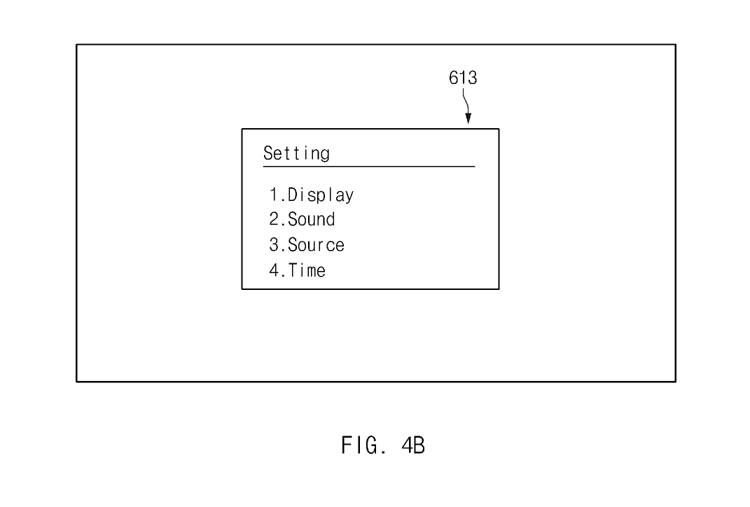

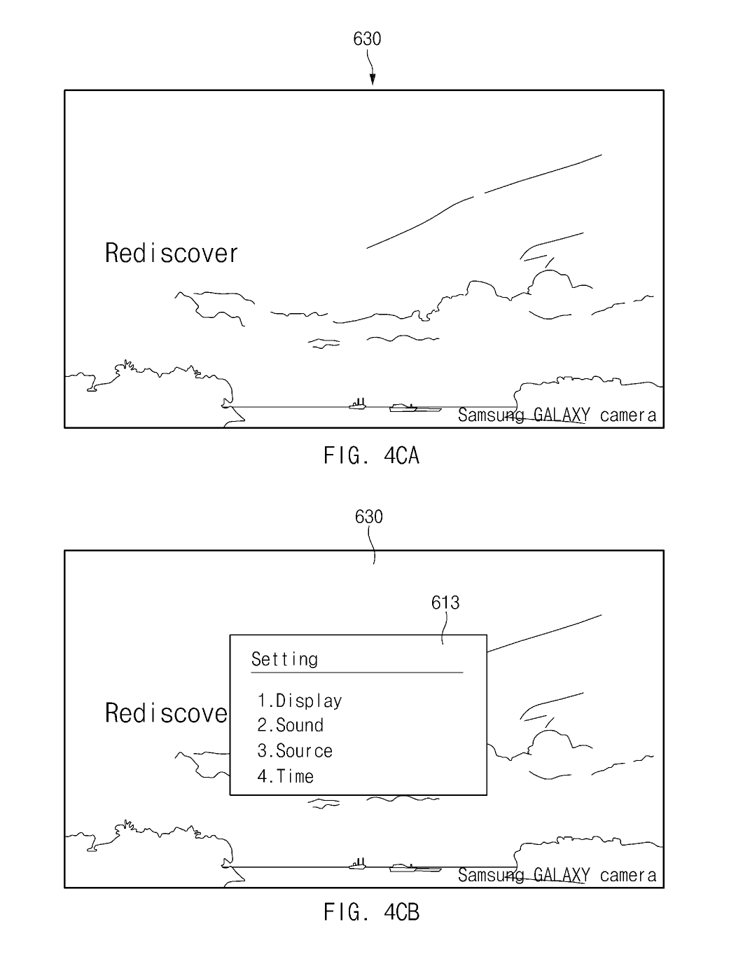

An operation that generates a UI image by the UI recognition module 155 and blends the generated UI image with the substitutional advertisement image in the DAR module 153 will be described below with reference to FIGS. 4AA, 4AB, 4B, 4CA, 4CB, 5AA, 5AB, 5BA, 5BB, and 5C.

According to an embodiment, the playback module 157 may play and output the substitutional advertisement received from the advertisement server 400. According to an embodiment, the playback module 157 may display the substitutional advertisement image in the display 130. For example, the playback module 157 may substitute the advertisement image received from the broadcasting reception apparatus 200 with the substitutional advertisement image in order to display the substitutional advertisement image in the display 130. The substitutional advertisement image may be an image into which a UI image generated by the UI recognition module 155 is blended by the DAR module 153. According to an embodiment, the playback module 157 may output an audio signal included in the substitutional advertisement through a speaker (not illustrated) in synchronization with the substitutional advertisement image.

FIGS. 4AA, 4AB, 4B, 4CA, and 4CB are views of a method in which a display apparatus blends a UI image of a broadcasting reception apparatus in a substitutional advertisement.

Referring to FIG. 4AA, a broadcasting image 610 that is received by the broadcasting reception apparatus 200 and displayed on the display apparatus 100 may include an advertisement image 611 and a UI image 613. For example, the broadcasting reception apparatus 200 may blend the UI image 613 into the advertisement image 611 in order to transmit the blended image to the display apparatus 100. The value of a blending alpha value α of the UI image 613 may be equal to one (1).

According to an embodiment, and referring to FIG. 4AA and FIG. 4AB, the display apparatus 100 may capture the broadcasting image 610 (hereinafter, referred to as a “first image”) received from the broadcasting reception apparatus 200 and a broadcasting image 620 (hereinafter, referred to as a “second image”) received from the advertisement server 400. The display apparatus 100 may compare the captured first image 610 with the captured second image 620 to verify an area in which the UI image 613 is blended into the first image 610. For example, the display apparatus 100 may determine that an area in which a respective pixel value of the captured first image 610 is different from a corresponding pixel value of the captured second image 620 is an area in which the UI image 613 of the first image 610 is blended.

Referring to FIG. 4B, the display apparatus 100 may remove the captured second image 620 from the captured first image 610, from an area other than the area in which the UI image 613 is blended, in order to generate the UI image 613.

Referring to FIG. 4CA and FIG. 4CB, the display apparatus 100 may blend the generated UI image 613 into a substitutional advertisement image 630 received from the advertisement server 400 in order to display the blended image in the display 130. For example, the value of the blending alpha value α of the UI image 613 may be equal to one (1).

As such, the display apparatus 100 may remove the broadcasting image 620 received from the advertisement server 400 from the broadcasting image 610 received from the broadcasting reception apparatus 200 in order to generate the UI image 613, and may blend the generated UI image 613 into the substitutional advertisement image 630 in order to display the blended image in the display 130, and thus may provide a user with a UX through a UI.

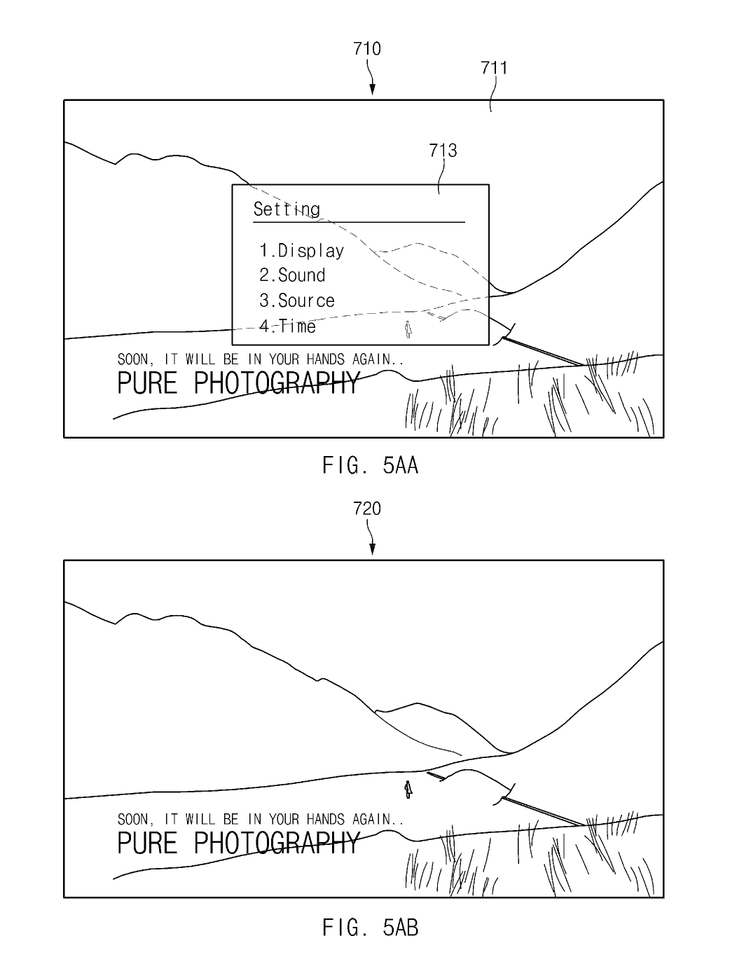

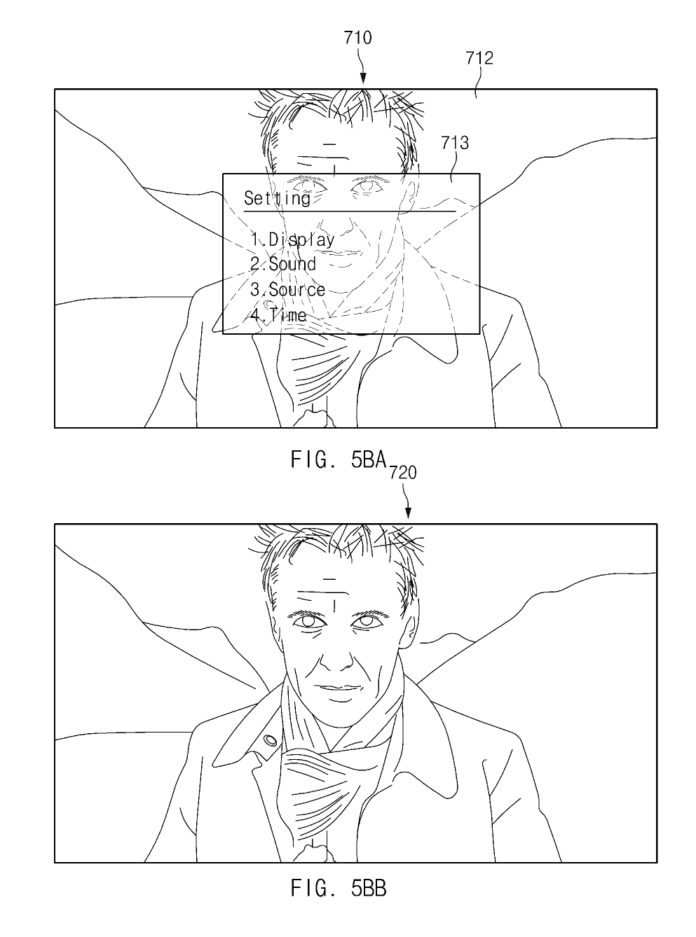

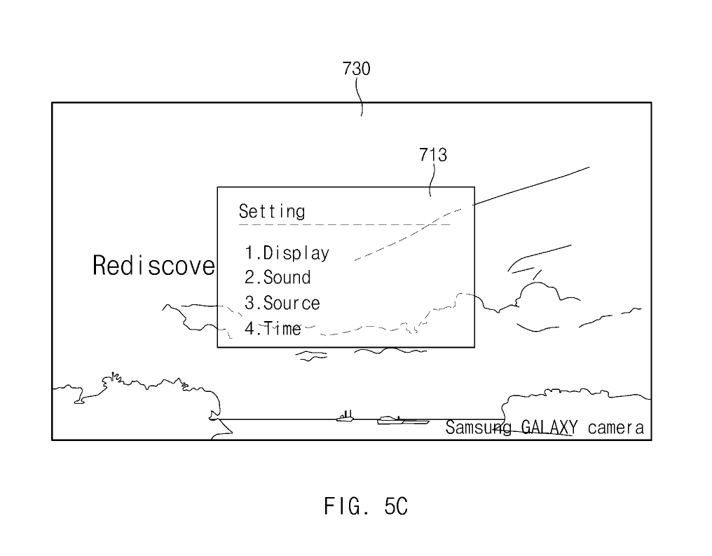

FIGS. 5AA, 5AB, 5BA, 5BB, and 5C are views of a method in which a display apparatus blends a UI image of a broadcasting reception apparatus in a substitutional advertisement.

Referring to FIGS. 5AA, 5AB, 5BA, and 5BB, a broadcasting image 710 received from the broadcasting reception apparatus 200 may include an advertisement image 711 or 712 and a UI image 713. For example, the broadcasting reception apparatus 200 may blend the UI image 713 into the advertisement image 711 or 712 in order to transmit the blended image to the display apparatus 100. The value of the blending alpha value α of the UI image 730 may be greater than zero (0) and less than one (1) (i.e., 0<α<1).

Referring to FIGS. 5AA and 5AB, in the case where it is determined that the UI image 713 is blended into the broadcasting image 710 received from the broadcasting reception apparatus 200, the display apparatus 100 may successively capture the broadcasting image 710 received from the broadcasting reception apparatus 200. For example, the display apparatus 100 may capture the broadcasting image 710 (hereinafter, referred to as a “first image”) received from the broadcasting reception apparatus 200 and the broadcasting image 720 (hereinafter, referred to as a “second image”) received from the broadcasting server 500, at a first time t1. The display apparatus 100 may calculate a pixel value P1C of the first image 710 captured at the first time t1 and a pixel value P1ORG of the second image 720 captured at the first time t1.

Referring to FIGS. 5BA and 5BB, the display apparatus 100 may capture the first image 710 and the second image 720 at a second time t2. The display apparatus 100 may calculate a pixel value P2C of the first image 710 captured at the second time t2 and a pixel value P2ORG of the second image 720 captured at the second time t2.

According to an embodiment, the pixel values P1C and P2C of the first image 710 respectively captured at the first time t1 and the second time t2, the pixel values P1ORG and P2ORG of the second image 720 respectively captured at the first time t1 and the second time t2, and respective pixel values P1OSD and P2OSD of UI image at the first time t1 and the second time t2 may be obtained according to Equation 1 and Equation 2. Each pixel value may be divided into a respective plurality of sub pixel values (e.g., a red-green-blue (RGB) value) and may be represented.

P1C_R=(1−α)*P1ORG_R+α*P1OSD_R

P1C_G=(1−α)*P1ORG_G+α*P1OSD_G

P1C_B=(1−α)*P1ORG_B+α*P1OSD_B Equation 1

P2C_R=(1−α)*P2ORG_R+α*P2OSD_R

P2C_G=(1−α)*P2ORG_G+α*P2OSD_G

P2C_B=(1−α)*P2ORG_B+α*P2OSD_B Equation 2

P1C_R, P1C_G, and P1C_B may be sub pixel values of the first image 710 captured at the first time t1; P2C_R, P2C_G, and P2C_B may be sub pixel values of the first image 710 captured at the second time t2; P1ORG_R, P1ORG_G, and P1ORG_B may be sub pixel values of the second image 720 captured at the first time t1; P2ORG_R, P2ORG_G, and P2ORG_B may be sub pixel values of the second image 720 captured at the second time t2; P1OSD_R, P1OSD_G, and P1OSD_B may be sub pixel values of the UI image at the first time t1; and P2OSD_R, P2OSD_G, and P2OSD_B may be sub pixel values of the UI image at the second time t2. Since the UI image is not changed from the first time t1 to the second time t2, P1OSD_R may be equal to P2OSD_R, P1OSD_G may be equal to P2OSD_G, and P1OSD_B may be equal to P2OSD_B.

According to an embodiment, the display apparatus 100 may select one sub pixel (e.g., R) from among a plurality of sub pixels in order to calculate the value of blending alpha α. The selected sub pixel may be a sub pixel for which the pixel value thereof is less than an upper limit value (e.g., 255) and greater than a lower limit value (e.g., 0). As such, the calculated value of blending alpha α may be obtained by applying the following Equation 3.

α=1−(P2C_R−P1C_R)/(P2ORG_R−P1ORG_R) Equation 3

According to an embodiment, the display apparatus 100 may remove the captured second image 720 from the captured first image 710, in order to generate the UI image 713 based on the calculated value of blending alpha α. For example, the display apparatus 100 may calculate the sub pixel value of the UI image 713 by substituting the calculated value of blending alpha α into Equation 4 below. Equation 4 below may be obtained by combining Equation 1 and Equation 2. In Equation 4 below, the pixel value P1OSD of the UI image 713 may be represented by deducting the pixel value P1ORG of the second image 720 captured at the first time t1 from the pixel value P1C of the first image 710 captured at the first time t1. As such, the display apparatus 100 may generate the UI image 713 by using the pixel value P1OSD of the UI image 713.

P1OSD_R=(P1C_R−(1−α)*P1ORG_R)/α

P1OSD_G=(P1C_G−(1−α)*P1ORG_G)/α

P1OSD_B=(P1C_B−(1−α)*P1ORG_B)/α Equation 4

Referring to FIG. 5C, the display apparatus 100 may blend the generated UI image 713 into a substitutional advertisement image 730 received from the advertisement server 400 in order to display the blended image in the display 130. For example, the value of alpha α of the UI image 713 may be the same as the calculated value of blending alpha α.

According to an embodiment, the display apparatus 100 may obtain the pixel value of the UI image by using a sub pixel value (e.g., red-green-green-blue (RGGB), red-green-blue-white (RGBW), YUV, or the like) that is different from the RGB value.

As such, in the case where the value of blending alpha α of the UI image 713 is greater than zero (0) and less than one (1) (i.e., 0<α<1), the display apparatus 100 may calculate the value of blending alpha α of the UI image 713, and may remove the broadcasting image 720 received from the broadcasting server 500 from the broadcasting image 710 received from the broadcasting reception apparatus 200 in order to generate the UI image 713 based on the calculated value of blending alpha α, and thus may blend the UI image 713 into the substitutional advertisement image 730 such that the UI image 713 is the same as the UI image in the broadcasting image 710 received from the broadcasting reception apparatus 200, in order to display the blended image on the display 130.

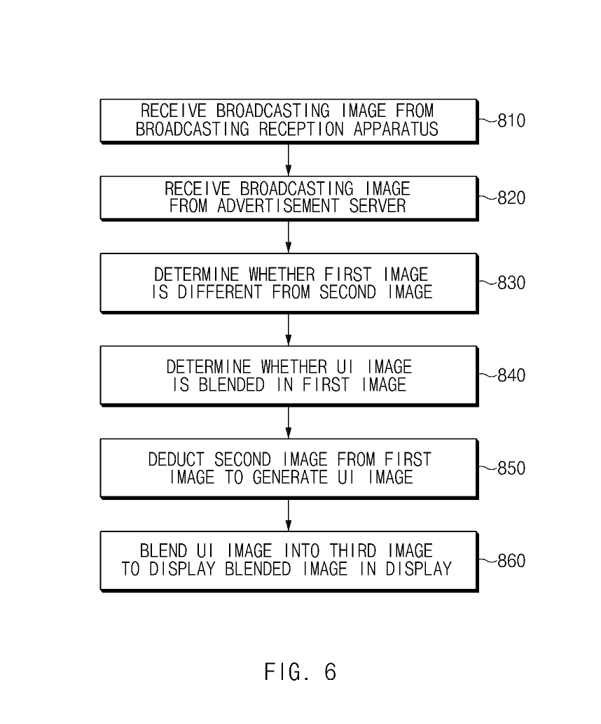

FIG. 6 is a flowchart illustrating a control method of a display apparatus, according to an embodiment.

The flowchart illustrated in FIG. 6 may include operations processed by the above-described display apparatus 100. Thus, although omitted below, the descriptions of a display apparatus given with reference to FIGS. 1 to 5C may be applied to the flowchart illustrated in FIG. 6.

According to an embodiment, in operation 810, the display apparatus 100 may receive a broadcasting image from the broadcasting reception apparatus 200. For example, the broadcasting image may include an advertisement image received from the broadcasting server 500 and a UI image generated by the broadcasting reception apparatus 200.

According to an embodiment, in operation 820, the display apparatus 100 may receive a broadcasting image from the advertisement server 400. For example, the broadcasting image may include the advertisement image.

According to an embodiment, in operation 830, the display apparatus 100 may determine whether the broadcasting image (hereinafter, referred to as a “first image”) received from the broadcasting reception apparatus 200 is different from the broadcasting image (hereinafter, referred to as a “second image”) received from the advertisement server 400.

According to an embodiment, if the first image is different from (or when the first image is determined to be different from) the second image, in operation 840, the display apparatus 100 may determine that the UI image is blended in the first image.

According to an embodiment, if (i.e., in response to determining that) the UI image is blended in the first image, in operation 850, the display apparatus 100 may remove the second image from the first image in order to generate the UI image.

According to an embodiment, in operation 860, the display apparatus 100 may blend the generated UI image into the substitutional advertisement image (hereinafter, referred to as a “third image”) received from the advertisement server 400 in order to display the blended image in the display 130.

According to various embodiments, at least a part of an apparatus (e.g., modules or functions thereof) or a method (e.g., operations) may be, for example, implemented by instructions stored in a transitory or non-transitory computer-readable storage media in the form of a program module. Each instruction, when executed by a processor, may cause the processor to perform a function corresponding to the instruction. A non-transitory computer-readable recording medium may include any of a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk), an embedded memory, and the like. The one or more instructions may contain a code made by a compiler or a code executable by an interpreter.

While the present disclosure has been shown and described with reference to various embodiments thereof, it will be understood by those having ordinary skill in the art that various changes in form and details may be made therein without departing from the spirit and scope of the present disclosure as defined by the appended claims and their equivalents.

What is claimed is:

1. A display apparatus comprising:
a communication interface connected to each of a broadcasting reception apparatus and a server;
a display configured to display an image; and
a processor electrically connected to each of the communication interface and the display,
wherein the processor is configured to:
receive a first image from the broadcasting reception apparatus;
receive a second image from the server;
receive, from the server, a third image with which the first image is substituted and which is to be displayed in the display;
determine whether a user interface (UI) image generated by the broadcasting reception apparatus is blended into the first image;
in response to determining that the UI image is blended into the first image, remove the second image from the first image in order to generate the UI image;
blend the UI image into the third image in order to generate a blended image; and
display, in the display, the blended image.

2. The display apparatus of claim 1, wherein the first image includes a first advertisement image and the second image includes a second advertisement image, and
wherein the third image includes a substitutional advertisement image.

3. The display apparatus of claim 1, wherein the processor is further configured to:
compare a first pixel value of the first image with a second pixel value of the second image; and
when a number of pixels for which a pixel value thereof is equal is greater than or equal to a predetermined number, determine that the UI image is blended into the first image.

4. The display apparatus of claim 1, further comprising:
a memory in which information about a display area of the UI image is stored,
wherein the processor is further configured to:
determine whether the UI image is blended into the first image, based on the stored information about the display area of the UI image.

5. The display apparatus of claim 4, wherein the processor is further configured to:
verify an area within which pixel values in the first image are different from pixel values in the second image; and
compare the verified area with the display area of the UI image to determine whether the UI image is blended into the first image.

6. The display apparatus of claim 1, wherein the processor is further configured to:
compare a first pixel value of a first pixel of the first image with a second pixel value of a second pixel of the second image to determine whether the first image is different from the second image; and
when the first image is determined to be different from the second image, determine whether the UI image is blended into the first image.

7. The display apparatus of claim 1, wherein the processor is further configured to:
capture the first image at a first time, and capture the second image at a second time;
calculate an alpha value of the UI image by using a respective pixel value of a corresponding pixel of each of the first image and the second image; and
generate the UI image based on the alpha value.

8. The display apparatus of claim 7, wherein the processor is further configured to:
calculate the alpha value of the UI image by using a pixel value of at least one pixel of an area in which the UI image of the first image is included.

9. The display apparatus of claim 7, wherein the processor is further configured to:
select a sub pixel from among a plurality of sub pixels included in the corresponding pixel; and
calculate the alpha value of the UI image by using a pixel value of the selected sub pixel.

10. The display apparatus of claim 9, wherein the processor is further configured to:
select the sub pixel, which has a pixel value that falls within a predetermined range, from among the plurality of sub pixels.

11. A controlling method of a display apparatus, the method comprising:
receiving a first image from a broadcasting reception apparatus;
receiving a second image from a server;
receiving, from the server, a third image with which the first image is substituted and which is to be displayed in a display;
determining whether a user interface (UI) image generated by the broadcasting reception apparatus is blended into the first image;
in response to determining that the UI image is blended into the first image, removing the second image from the first image in order to generate the UI image;
blending the UI image into the third image in order to generate a blended image; and
displaying the blended image in the display.

12. The method of claim 11, wherein the determining whether the UI image is blended into the first image includes:
comparing a first pixel value of the first image with a second pixel value of the second image; and
when a number of pixels for which a pixel value thereof is equal is greater than or equal to a predetermined number, determining that the UI image is blended into the first image.

13. The method of claim 11, wherein the determining whether the UI image is blended into the first image includes:
determining whether the UI image is blended into the first image, based on information about a display area of the UI image that is stored in a memory of the display apparatus.

14. The method of claim 13, wherein the determining whether the UI image is blended into the first image includes:
verifying an area within which pixel values in the first image are different from pixel values in the second image; and
comparing the verified area with the display area of the UI image to determine whether the UI image is blended into the first image.

15. The method of claim 11, further comprising:
comparing a first pixel value of a first pixel of the first image with a second pixel value of a second pixel of the second image to determine whether the first image is different from the second image; and
wherein the determining whether the UI image is blended into the first image includes:
when the first image is determined to be different from the second image, determining whether the UI image is blended into the first image.

16. The method of claim 11, wherein the generating the UI image includes:
capturing the first image at a first time, and capturing the second image at a second time;
calculating an alpha value of the UI image by using a respective pixel value of a corresponding pixel of each of the first image and the second image; and
generating the UI image based on the alpha value.

17. The method of claim 16, wherein the calculating the alpha value of the UI image includes:
calculating the alpha value of the UI image by using a pixel value of at least one pixel of an area in which the UI image of the first image is included.

18. The method of claim 16, wherein the calculating the alpha value of the UI image includes:
selecting a sub pixel from among a plurality of sub pixels included in the corresponding pixel; and
calculating the alpha value of the UI image by using a pixel value of the selected sub pixel.

19. The method of claim 18, wherein the selecting of the specified sub pixel includes:
selecting the sub pixel, which has a pixel value that falls within a predetermined range, from among the plurality of sub pixels.

20. A non-transitory computer-readable recording medium having recorded thereon a program performing a method, the method comprising:
receiving a first image from a broadcasting reception apparatus;
receiving a second image from a server;
receiving, from the server, a third image, with which a second image and the first image is substituted and which is to be displayed in a display;
determining whether a UI image generated by the broadcasting reception apparatus is blended into the first image;
in response to determining that the UI image is blended into the first image, removing the second image from the first image in order to generate the UI image;
blending the UI image into the third image in order to generate a blended image; and
displaying the blended image in the display.
